(19) United States
(12) Patent Application Publication
(10) Pub. No.: US 2026/0172524 A1
(43) Pub. Date: Jun. 18, 2026

(54) Method for printing on a paper web

(71) Applicant: SWISS KRONO Tec AG, Luzern (CH)

(72) Inventor: Falko Geitz, Zernitz-Lohm (DE)

(21) Appl. No.: 18/853,979

(22) PCT Filed: Apr. 5, 2023
(86) PCT No.: PCT/EP2023/058983

§ 371 Date: Oct. 3, 2024

(30) Foreign Application Priority Data
Apr. 8, 2022 (EP) 22167468.2

(51) Int. Cl. H04N 1/60

(52) U.S. Cl. CPC H04N 1/6036; H04N 1/6027

(57) ABSTRACT

The disclosure relates to a method for printing a paper web with a print motif by means of a digital printing facility, wherein the method includes the following steps: providing a digital print template, which contains digital information on the print motif, and a target tone value of a color of the print motif; printing onto a surface of the paper web by means of the digital printing facility on the basis of the print template; determining at least one actual tone value of the color at at least one point of the printed surface; comparing the determined actual tone value with the target tone value; and correcting the tone value in the digital information of the print template on the basis of the results of the comparison.

### FIELD OF INVENTION

The invention relates to a method for printing a print motif on a paper web by means of a digital printing facility.

### BACKGROUND

Print motifs are printed on paper webs for a wide variety of reasons. For example, they are used to produce panels or boards that can be used, for example, as floor, wall or ceiling coverings or furniture boards. When manufacturing floor panels in particular, it is desired and very advantageous if the paper webs featuring the print motif do not differ from each other in terms of color. In particular, this is the case when panels with the same decor are produced at different times, meaning that the same decor is printed onto different paper webs at different times. In order to achieve reproducibility and color fidelity, it is known from the prior art to store a digital print template.

This digital print template contains digital information on the print motif. Using this digital print template it is possible to control and thus use the digital printing facility to print a print motif onto the paper web. Various methods are known from the prior art that use the digital print template to print a print motif onto the paper web. This copy is then compared with the target motif. A decision can then be taken on the basis of this comparison as to whether the control commands and parameters contained in the digital print template, such as color values, that are used during printing enable sufficient quality of the print result, i.e. the paper web bearing the print motif.

WO 2019/234147A1, for example, describes a method in which a digital target image is generated from hyperspectral digital images. Hyperspectral images are images that not only contain information on visible colors, i.e. frequencies in the visible light range, but also in a frequency range beyond it. The target images produced in this manner are then compared with actual images generated from printed copy of the paper web. This result of this comparison is decisive for the further procedure. If the comparison is satisfactory, i.e. the actual image sufficiently corresponds to the specifications of the target image, production can begin or the actual image at least further processed. However, if the comparison is not satisfactory, it is not clear what has to be done to change this.

The disadvantage is that this “resampling”, i.e. checking, adjusting and setting the various production parameters of the digital printing system, is time-consuming. This is necessary because external influences, such as changes in temperature and humidity, the ink used, any primer used and/or the paper web used, can affect the quality of the print motif. It is therefore necessary to correct, or at least check, the print quality. However, the methods known from the prior art are time-consuming and/or material-intensive and therefore expensive. In addition, although deviations of the printed copy of the print motif on the paper web from a basic sample or a digital print template can be determined, the necessary correction is usually not precisely recognizable and therefore cannot be implemented in a targeted manner. Rather, “resampling” often requires multiple iterative steps and possibly the experience and expertise of an employee operating the digital printing facility in order to achieve the desired result as quickly as possible.

### SUMMARY

The invention is therefore based on the task of proposing a method with which these disadvantages can be eliminated or at least reduced. The invention solves the addressed task by way of a method for printing a print motif on a paper web by means of a digital printing facility with the methods as described below.

### DETAILED DESCRIPTION

The invention solves the addressed task by way of a method for printing a print motif on a paper web by means of a digital printing facility, wherein the method comprises the following steps:
providing a digital print template, which contains digital information on the print motif, and a target tone value of a color of the print motif,
printing onto a surface of the paper web by means of the digital printing facility on the basis of the print template,
determining at least one actual tone value of the color at at least one point of the printed surface,
comparing the determined actual tone value with the target tone value, and
correcting the tone value in the digital information of the print template on the basis of the results of the comparison.

The tone value of a color specifies the different gradings of the color between light and dark in percent. When the tone value is 0% there is no color. The corresponding point that exhibits this tone value has therefore not been printed on and is light. Such color areas are also referred to as highlights. They are referred to as light or highlights regardless of the color of the surface to which the print is applied. In contrast, a tone value of 100% indicates maximum color, also referred to as full tone, which is accordingly considered to be dark. Dark color areas are also known as depths. The digital information on the print motif contained in the digital print template also contains the target tone value of a color of the print motif. Preferably, the digital information contains all target tone values of all colors used during printing of the print motif. For every color used, there is preferably a target tone value of the corresponding color or corresponding colors stored for every printed point of the paper web, for example every pixel of the print motif.

In the method according to the invention, the digital print template is used to print the print motif onto a paper web and thus produce a print copy or sample copy. This is now used to determine an actual tone value of the color at at least one point of the printed surface; it is then compared with the target tone value provided for the corresponding color at the respective point. The tone value is corrected in the digital information of the print template on the basis of this comparison. Using the corrected information of the print template, a further sample copy can subsequently be printed or production commenced.

An advantage of the method according to the invention is that a direct production parameter is used for the comparison with a corresponding target value. This is not the case in the prior art. Using the approach according to the invention, it is possible to determine a direct corrective measure, irrespective of what caused the deviation of the actual tone value from the target tone value. Preferably, it is immediately recognizable which measure can or even must be taken to rectify or at least reduce a possible deviation of the actual image from the target image. In especially preferred embodiments, at least one such corrective measure is proposed and output by means of a corresponding output unit, for example a monitor. Alternatively or additionally, the electrical control unit, preferably the electronic data processing device that controls the digital printing facility, is configured to determine at least one suitable corrective measure from the results of the comparison of the actual tone value and the target tone value and, especially preferably, to implement it.

The target tone values are preferably determined on the basis of a printed template. A printed template is then generated that depicts the desired print motif and fulfils all quality requirements in the process. Tone values are then captured from this printed template. This is preferably, but not necessarily, done hyperspectrally. The tone values detected in this way are then labelled and saved as a master sample. If the print motif of the printed template is then to be printed on a paper web, at least one tone value from the master sample is provided as a target tone value and used in the method according to the invention. It is no longer necessary to refer to the printed template.

According to the invention, the tone value in the digital information of the print template is corrected on the basis of the result of comparing actual tone values and target tone values. This does not refer to a calibration of the digital printing facility; rather, the print template that contains the print motif, or to put it simply the file to be printed, is adjusted. This does not affect the calibration of the printing facility. For the most part, the parameters that may lead to deviations of the actual tone values from the target tone values do not depend on the digital printing facility. This refers, for example, to room temperature and humidity or the type and quality of the paper used. Therefore, most deviations are not “errors” of the digital printing facility, meaning that a new calibration is not necessary to correct the parameters responsible for these deviations and to offset the deviations.

Preferably, a tone value is provided as the target tone value that is read or determined from the digital information of the digital template.

Preferably, target tone values of different colors are provided and the actual tone values of several of these colors, preferably all of these colors, are determined. This not only determines the quality of the print of a single color and/or a single color value of one or more colors. It ensures that multiple tone values of one or multiple colors or a tone value of multiple colors are checked and compared with the corresponding target tone value that has been provided.

Preferably, the actual tone value of a color is determined by measuring tone values of the color at different points of the printed surface that have the same target tone value for this color. Preferably, these tone values of the color determined in this way are then averaged to determine the actual tone value of the color. If different deviations of the respective tone values from the target tone value appear at different points of the printed surface, they would be less significant due to the formation of the average value.

When correcting the tone value, it is preferably corrected in the digital information of the print template in an identical manner for the entire print motif. A tone value of a particular color may be required at different points of the print motif. In principle, it is possible to determine the actual tone value at each of these points in the sample copy, to compare it with the target tone value and to individually correct the tone value at each point depending on the particular deviation. To be able to correct them comprehensively, however, the deviation between actual tone value and target tone value would have to be determined at every point of the sample copy, for example at each pixel of the print motif. This is very time-consuming and usually not feasible.

It is therefore advantageous to correct the tone value in the digital information of the print template for a certain color in a uniform manner for the whole print motif. The basis of this correction can be the comparison of an individual, determined actual tone value with the respective target tone value. However, a better basis is provided if the actual tone value to be compared with the target tone value is determined by averaging over a plurality, for example at least 5, preferably at least 10, particularly preferably at least 20 individually determined tone values of the respective color.

In one preferred embodiment, a difference between the actual tone value and the target tone value is determined when comparing the actual tone value and the target tone value. This difference is used as a basis for correcting the tone value in the digital information. In one particularly preferred embodiment, the tone value is correcting by subtracting the difference from the tone value. For example, if the actual tone value is 10 percentage points greater than the target tone value, the difference is consequently 10. In said particularly preferred embodiment, this difference is subtracted from the tone value, thereby reducing it by this value. During the next print, the tone value used to control the digital printing facility is therefore lower, so that the print result corresponds more closely to the originally intended print motif, i.e. the target tone value.

Preferably, multiple actual tone values of one color are determined and output in a value table and/or a gradation curve. In the process, the actual tone values are compared with the corresponding target tone values. With a perfect print, in which there is no difference between the target tone value and the actual tone value, the gradation curve is a straight line with a gradient of 1. If the gradation curve generated from the comparisons of the actual tone values and the target tone values deviates from this ideal form by more than a given tolerance, it is easily identifiable from the gradation curve itself how the control parameters of the digital printing facility have to be changed to achieve a better results, i.e. a gradation curve with a smaller deviation from the specified optimal curve.

Preferably, a respective point of the printed surface is captured, preferably hyperspectrally captured, with a scanner, an image scanner, a camera and/or a light sensor in order to determine an actual tone value. The actual tone value of the color is preferably determined at different points of the printed surface and compared with the respective target tone value.

In one preferred embodiment, the paper web is impregnated after printing on the surface and pressed with a core, preferably made of a wood-based material, before the at least one actual tone value is determined.

1. A method for printing a paper web with a print motif by use of a digital printing facility, wherein the method comprises:
providing a digital print template, which contains digital information on the print motif, and a target tone value of a color of the print motif,
printing onto a surface of the paper web by the digital printing facility on a basis of the digital print template,
determining at least one actual tone value of the color at at least one point of the printed surface,
comparing the determined actual tone value with the target tone value, and
correcting the tone value in the digital information of the print template based on the results of the comparison.

2. The method according to claim 1, wherein target tone values of different colors are provided and the actual tone values of several of these colors are determined.

3. The method according to claim 1, wherein the actual tone value of the color is determined by measuring tone values of the color at different points of the printed surface which have a same target tone value for the color, and averaging the measured tone values.

4. The method according to claim 1, wherein a difference between the actual tone value and the target tone value is determined when comparing the actual tone value and the target tone value.

5. The method according to claim 4, wherein the tone value is corrected by subtracting a difference from the tone value.

6. The method according to claim 1, wherein multiple actual tone values of a color are determined and is output as a value table and/or a gradation curve.

7. The method according to claim 1, wherein a respective point of the printed surface is captured with a scanner, an image scanner, a camera and/or a light sensor to determine an actual tone value.

8. The method according to claim 1, wherein the actual tone value of the color is determined at various points of the printed surface and compared with the target tone value.

9. The method according to claim 1, wherein the paper web is impregnated after printing on the printed surface and pressed with a core before the at least one actual tone value is determined.

10. The method according to claim 2, wherein the target tone values of the different colors are provided and the actual tone values of all of the colors, are determined.

11. The method according to claim 1, wherein a respective point of the printed surface is hyperspectrally captured with a scanner, an image scanner, a camera and/or a light sensor in order to determine an actual tone value.

12. The method according to claim 9, wherein the core is a wood-based material.
